(19) United States
(12) Patent Application Publication
(10) Pub. No.: US 2002/0165785 A1
(43) Pub. Date: Nov. 7, 2002

(54) System for processing material, output unit for information on processing material and output method for information on processing material

(76) Inventor: Yukihiko Nansho, Osaka (JP)

Correspondence Address: BANNER & WITCOFF, 1001 G STREET N W, SUITE 1100, WASHINGTON, DC, 20001, US

(21) Appl. No.: 09/846,358

(22) Filed: May 2, 2001

(30) Foreign Application Priority Data
Nov. 2, 2000 (JP) P2000-336443

(51) Int. Cl. G06F 17/60

(52) U.S. Cl. 705/26

(57) ABSTRACT

This invention intends to provide a system for producing commodities which can meet a demander's requirement with attempting effective use of less demanded material or unefficient processing equipment.

In this invention a manufacturer of a final commodity presents a required specification for elements constituting a commodity and according to the required specification a material supplier registers information on material which the material supplier can supply and the processor registers information on processing which the processor can supply. In addition, a person who intends to purchase a specified commodity inputs desired information on the material or the processing for the commodity and the information on the material and the processing which corresponds to the desired information is output.

### BACKGROUND OF THE INVENTION AND RELATED ART STATEMENT

This invention relates to a system for making a final commodity by processing a variety of materials.

Conventionally, in an industry of making a final commodity by processing a plurality of materials to a certain component unnecessary materials or processing facilities are likely to be generated during a process of procuring materials or of processing the materials. An industry of manufacturing furniture by making use of wooden-ware will be explained as an example. In a forest where trees are afforested thinned-out woods are cut to thin out the forest so as to make an interval of the trees uniform and the deforested thinned-out woods are likely to be left as they are. As a measure to deal with this situation, some of forestry associations in a city, town or village having mountains or forests make a commodity such as “a log stakes” by making use of the thinned-out woods. However, the commodity such as a “log stake” does not meet a demander's requirement. This leads to a present situation where thinned-out woods are not utilized as a real worthy commodity.

It can be considered as one of the causes that there is no enterprises which produces a commodity with a through an operation from obtaining materials to manufacturing final commodities or there is no enterprises nor information network that grasps all of demander's requirements accurately. More specifically, an enterprise which supplies materials does not grasp information on what kind of commodities the materials can be utilized to or whether the materials can be processed into the commodities that the demander desires or not although it keeps a variety of materials such as thinned-out woods. In addition, an enterprise which manufacturers final commodities by processing supplied materials does not grasp information on how and where to get the material which the demander desires.

Not only in the industry of wood commodities but also in industries of supplying a variety of materials or industries where producers and manufacturers are independent there exist materials of no use or processing facilities of less effective in operation.

In view of the above problems, the present claimed invention intends to provide a system for producing commodities that can meet a demander's requirement with attempting effective use of material having conventionally less demand or processing facilities which have not been operated efficiently.

### OBJECT AND SUMMARY OF THE INVENTION

In order to solve the above problems the present claimed invention is so arranged that a material supplier registers information on material which the material supplier can supply and the processor registers information on processing which the processor can supply. In addition, a person who intends to purchase a specified commodity inputs desired information on the material or the processing for the commodity and the information on the material and the processing which corresponds to the desired information is output.

As mentioned above, the material supplier and the processor register what they can supply and the demander can select the desired material and processing from the registered information. Then, for example, if a demander selects material of less utility value such as thinned-out woods, the materials or processing facilities can be utilized effectively to meet a demander's requirement.

However, a trouble might happen that it becomes impossible to assemble a commodity with using the material in a final step to manufacture the commodity in case the material for the commodity is selected by the demander. As a result, it is preferable that a manufacturer presents a required specification for components of the commodity and a material supplier or a processor registers information on the material or the processing for the specification, and then a demander selects the material or the processing within the range of the specification. In accordance with the arrangement, the manufacturer can not only make the commodity smoothly but also improve quality of the commodity.

In addition, since thinned-out woods which have conventionally less utility value are registered and information on the thinned-out woods is output, it becomes possible to effectively utilize the thinned-out woods which have a true demand.

### BRIEF DESCRIPTION OF THE DRAWINGS

FIG. 1 is a general diagram of a system showing an embodiment of the present claimed invention.

FIG. 2 is a functional block diagram of the system in the embodiment.

FIG. 3 is a memory map of a server computer in the embodiment.

FIG. 4 is an overall flow chart of the system in the embodiment.

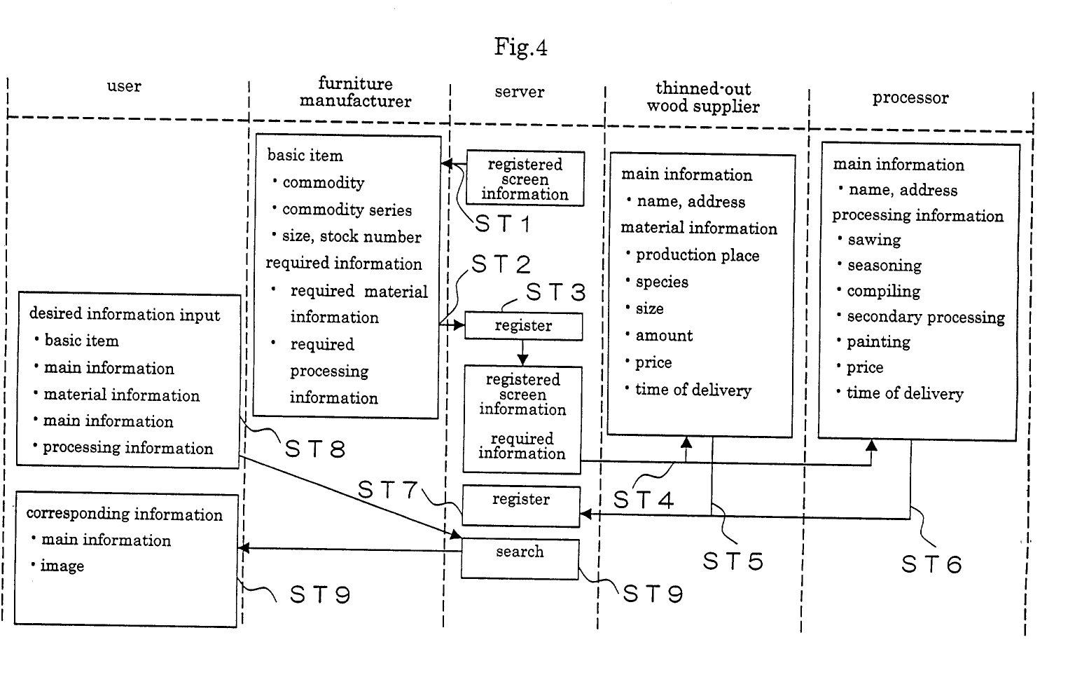

FIG. 5 is a screen flow chart of a client computer of a demander in the embodiment.

FIG. 6 is the screen flow chart of the client computer of the demander in the embodiment.

### DETAILED DESCRIPTION OF THE PRREFERRED EMBODIMENTS

The invention will be described in detail with reference to the embodiments thereof shown in the accompanying drawings.

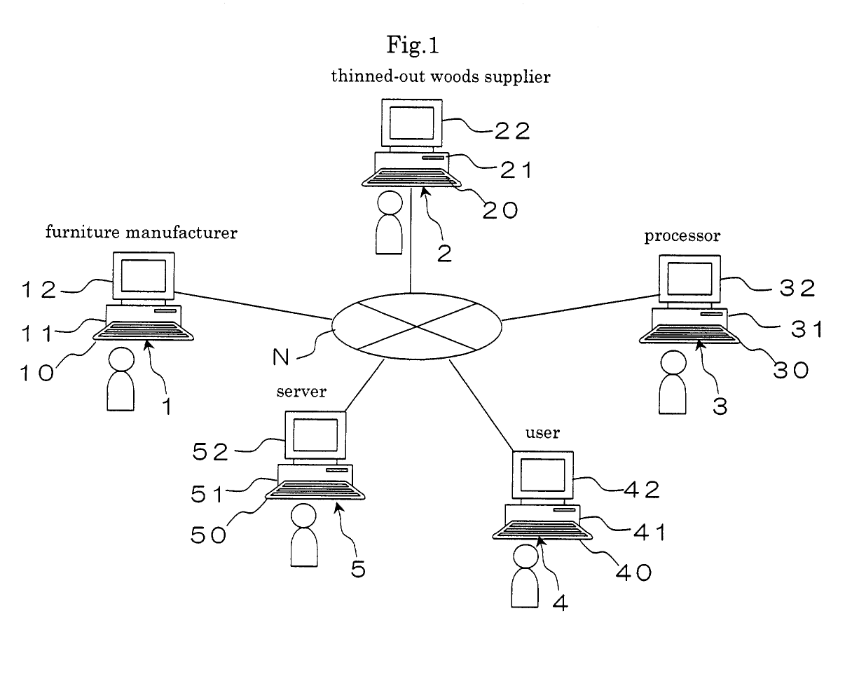

FIG. 1 is a general diagram of a system constituting a system of the invention and comprises a plurality of client computers 1 through 4 connectably arranged through a network N such as the Internet and a server computer 5. The client computers in this system comprise a client computer 1 operated by a furniture manufacturer which assembles a final commodity, a client computer 2 operated by a forest association which supplies materials such as thinned-out woods, a client computer 3 operated by a processor of the materials and a client computer 4 operated by mainly a purchaser of furniture, and further comprises the server computer 5 which stores information input by the client computers 1 though 4. The server computer 5 may also serve as a function of these client computers 1 though 4, however, in this embodiment it functions independently.

The client computer 1 provided on a side of the furniture manufacturer comprises an input means 10 comprising a keyboard with which a required specification for a commodity to be manufactured, material or processing is input by the furniture manufacturer, a body 11 to process data and a display means 12 comprising a display to display a predetermined output and is provided at a place where the furniture manufacturer or a person concerned can operate. The client computer 2 provided on a side of the supplier of the thinned-out woods comprises an input means 20 comprising a keyboard like the input means 10, a body 21 and a display means 22 comprising a display and is so arranged that information on materials such as thinned-out woods can be input based on the required specification presented by the furniture manufacturer. The client computer 3 provided on a side of the processor comprises an input means 30 such as a keyboard, a body 31 and a display means 32 such as a display and is so arranged that information on the processing such as lumbering or painting can be input based on the required specification presented by the furniture manufacturer. The client computer 4 provided on a side of a demander also comprises an input means 40 comprising a keyboard, a body 41 and a display means 42 comprising a display and is so made that a commodity to be sold which is presented by the furniture manufacturer can be searched and that a desired material or method of processing for the commodity can be selected or searched as well. The server computer 5 is provided to be connectable with these client computers 1 through 4 and comprises an input means 50, a body 51 and a display means 52 like the client computers 1 through 4. The server computer 5 stores information on the commodity, the material or the processing which is input with the client computers 1 through 4 and is so made that the demander can select or search the information.

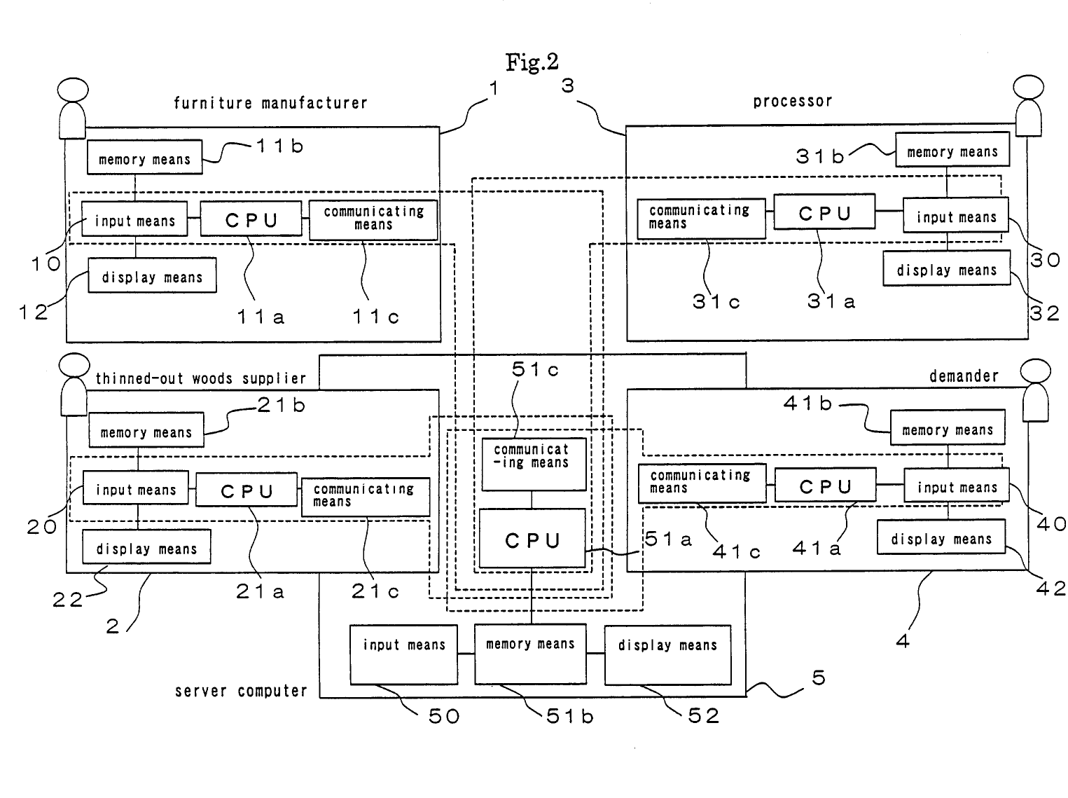

The FIG. 2 shows a functional block of thus arranged system. CPUs (11a, 21a, 31a, 41a, 51a) provided on the client computers 1 though 4 and the server computer 5 are to control each of the client computers 1 through 4 and the server computer 5 having the CPUs (11a, 21a, 31a, 41a, 51a) and so arranged to be operated by a program stored on each of memory means (11b, 21b, 31b, 41b, 51b). Each of the input means (10, 20, 30, 40, 50) is so arranged that the input data is received from an operator like a keyboard or a mouse, while each of the display means (12, 22, 32, 42, 52) is so arranged to display information which is input by the input means (10, 20, 30, 40, 50) or which is sent or received through the network N.

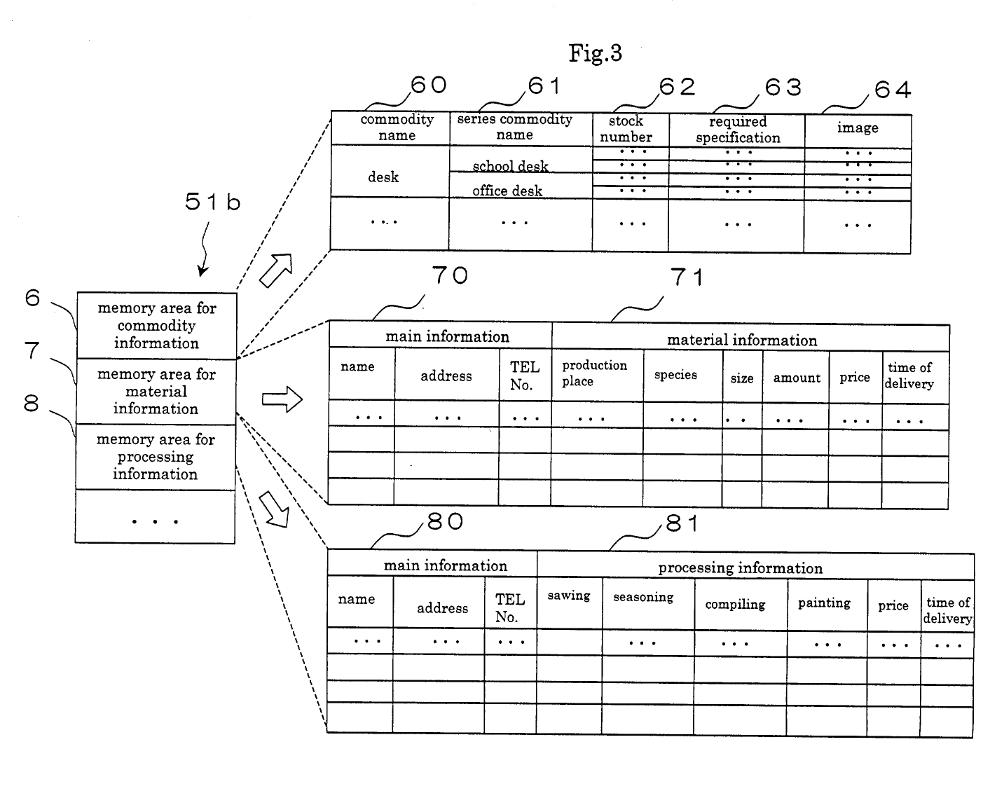

The memory means (11b, 21, 31, 41, 51b) stores a program for the client computers 1 through 4 and the server computer 5 and also stores information which corresponds to environment where the client computers 1 through 4 are arranged. For example, the memory means 51b of the server computer 5 stores, as shown in a memory map of FIG. 3, the information on the commodity or the required specification concerning the material or the processing presented by the furniture manufacturer, the information on the thinned-out woods registered by the material supplier or the information on the processing registered by the processor.

More specifically, the memory means 51b of the server computer 5 is provided with a memory area 6 for commodity information input by the client computer 1 of the furniture manufacturer, a memory area 7 for material information input by the client computer 2 of the thinned-out wood supplier and a memory area 8 for processing information input by the client computer 3 of the processor. The memory area 6 for commodity information has a memory area for a commodity name 60 such as a desk or a chair which is roughly classified for the convenience of a furniture manufacturer and a series commodity name 61 such as a school desk or an office desk and also stores a required specification 63 concerning materials which constitute the commodity or processing of the commodity corresponding to a stock number 62 of the series commodity name 61. Information on a production place, a species, a size, a shape or a number of thinned-out woods is input concerning the material and information on sawing, seasoning, compiling, a secondary processing or painting is input concerning the processing as the required specification 63. An image 64 of a finished commodity corresponding to the material or the processing can be stored for each stock number and can be output on the client computer 4.

The memory area 7 for material information stores main information 70 on a name, address or telephone number of the material supplier and material information 71 which is input by the material supplier from the client computer 2 through the network N. As the material information 71 stored is, concretely a production place, a species, a size, a shape or a number of the thinned-out woods in addition to an appointed date of delivery or a price thereof which is input corresponding to the required specification of the furniture manufacturer.

The memory area 8 for processing information stores main information 80 on a name, address or telephone number of the material supplier and processing information 81 which is input by the processor from the client computer 3 through the network N. The processing information 81 is input corresponding to the required specification of the furniture manufacturer. More concretely, as the processing information 81 stored is information on a size capable of or capacity of sawing, a size capable of seasoning or time to season, a size capable of compiling or a name of adhesive used, use or non-use of an NC router as a secondary processing or a maximum size capable of processing, a kind or a method of painting, time of delivery or a price.

Communicating means (11c, 21c, 31c, 41c, 51c) is so arranged to communicate with the other client computer or the server computer 5 through the network N and comprises a modem or the like.

In thus arranged functional block, the CPU 21a which controls the input means 20 and the communicating means 21c of the client computer 2 provided on the side of the material supplier and the CPU 51a which controls the communicating means 51c of the server computer 5 form a means for receiving material information, and the CPU 31a which controls the input means 30 and the communicating means 31c of the client computer 3 provided on the side of the processor and the CPU 51a which controls the communicating means 51c of the server computer 5 form a means for receiving processing information. The CPU 11a which controls the input means 10 and the communicating means 11c of the client computer 1 provided on the side of the furniture manufacturer and the CPU 51a which controls the communicating means 51c of the server computer 5 form a means for receiving requested information. The CPU 51a which controls the memory means 51b and the communicating means 51c of the server computer 5 form an output means.

Next explained will be a flow in which a furniture manufacturer, a material supplier or a processor inputs a predetermined data by the use of thus arranged system and a flow in which the demander searches material or processing method for a desired commodity based on the input information.

First, in case that the furniture manufacturer requests a specification for a commodity to be sold or the material supplier, the furniture manufacturer connects the client computer 1 of the furniture manufacturer with the server computer 5, gets (ST1) a registered screen information on the commodity to be sold and inputs a commodity name, a series commodity name, a size or a stock number as a basic item based on the registered screen information. As a requested specification of components constituting the commodity, material request information or processing request information is input (ST2) so as to register in the memory means 51 of the server computer 5, which enables the thinned-out wood supplier to make registration (ST3). If the client computer 2 of the side of the thinned-out wood supplier is connected with the server computer 5 after operation of registration, information on the registered screen for supplying material is sent from the server computer 5 to the client computer 2 and a required specification 63 registered in the memory means 51b of the server computer 5 is also sent (ST4). Based on the information thus received, the thinned-out wood supplier inputs and sends (ST5) material information such as a species, a size, a number or a price of the thinned-out woods which the supplier holds, and main information such as an address or a telephone number of the supplier so as to store (ST7) the material information and the main information in the memory area 7 for material information of the server computer 5. Similarly, if the client computer 3 of the side of the processor is connected with the server computer 5, information on the registered screen for processing is sent from the server computer 5 to the client computer 3 and a required specification 63 registered in the memory means 51b of the server computer 5 is also sent (ST4). Based on the information thus received, the processor inputs and sends (ST6) processing information such as sawing, seasoning, compiling, a secondary processing or painting and main information such as an address or a telephone number so as to store (ST7) the processing information and the main information in the memory area 8 for processing information of the server computer 5.

In case the demander searches a desired commodity by accessing the server computer 5 wherein registration has been completed, the demander inputs desired information on the commodity, material or processing (ST8) by the use of an input screen provided by the server computer 5.

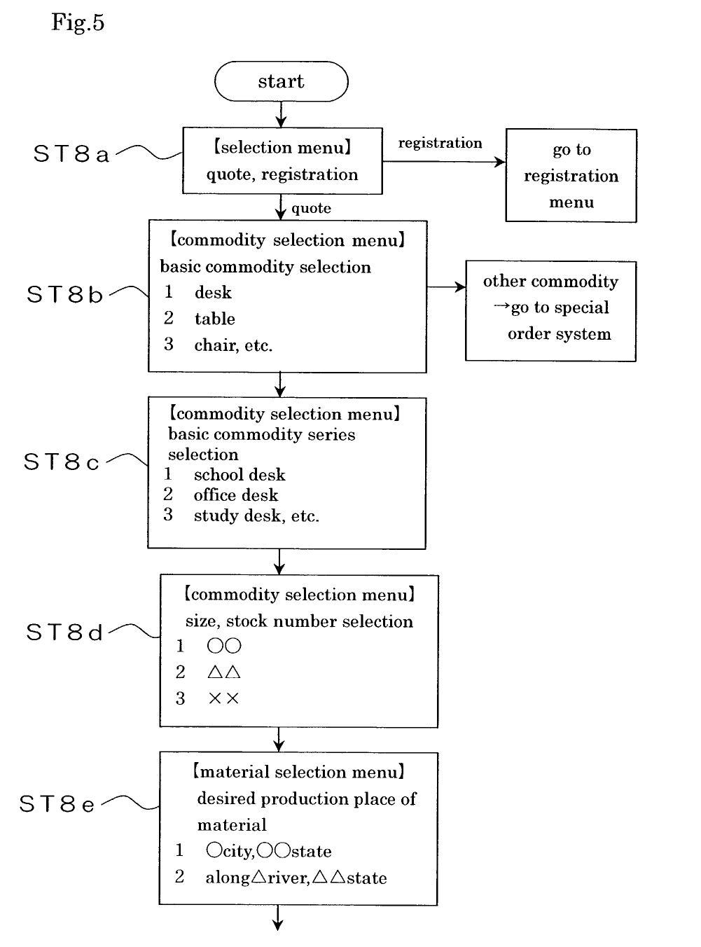

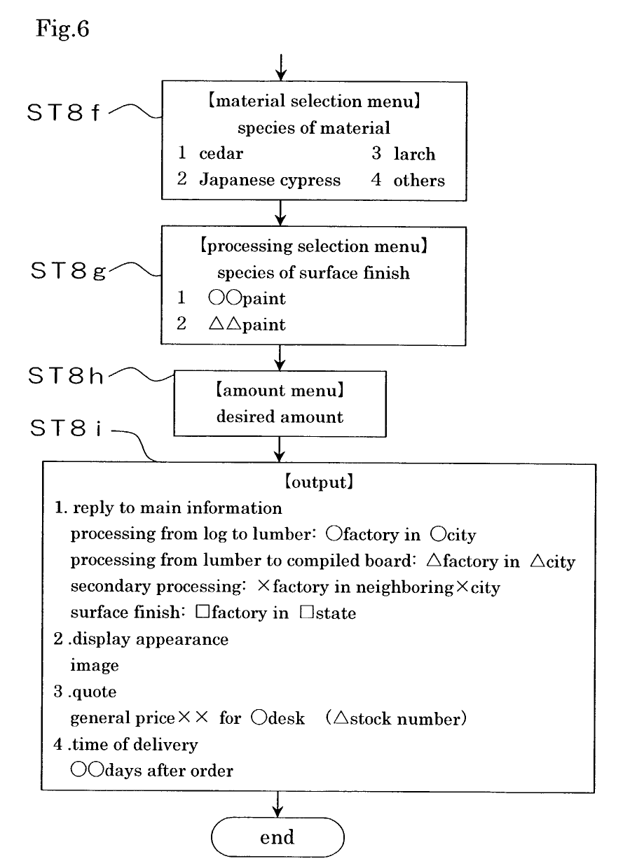

More specifically, when the demander accesses the server computer 5 and inputs a predetermined URL, information on an initial screen is sent from the server computer 5 and a screen to quote or to make registration is displayed (ST8a) on a display of the client computer 4 of the demander, as shown in FIG. 5 and FIG. 6. Then if the screen to quote is selected, a commodity name as a rough classification of the basic item registered by the furniture manufacturer is read out from a memory area 60 for a commodity name of the server computer 5 and the commodity names are displayed on a display of the client computer 4 so as to enable selection of the commodity name (ST8b). If one of the commodities, for example, a desk is selected from among the displayed commodity names, a series commodity name corresponding to the desk is read out from a memory area 61 for a series commodity name of the server computer 5 and displayed so as to enable selection of the series commodity name (ST8c). Corresponding to the selection of the series commodity name, a stock number corresponding to the series commodity name is read out from a memory area 63 for information on the stock numbers of the server computer 5 and is displayed so as to enable selection of the stock number (ST8d). Registration of information on the desired commodity is completed with the selection of the stock numbers.

Next, an input screen concerning preference for a production place of the material is provided in a display of the client computer 4 in order to allow the demander to input his or her preference for the material to the selected commodity and an input concerning a desired production place is allowed (ST8e). The desired production place can be input directly by the use of the keyboard as well as it scan be selected from information on the production place previously registered in the memory area 63 for specification information of the server computer 5. In case a desired production place is input, an input screen concerning a desired species of wood is displayed on the client computer 4 in order to allow the demander to input his or her preference for a species of wood (ST8f). In this case also, the desired species of wood can be input directly by the use of the keyboard as well as can be selected from information on the species of wood previously registered in the memory area 63 for specification information of the server computer 5.

When desired information on the material has been selected and input, desired information on surface finish and other desired information on processing can be input (ST8g) to allow an input of a processing method or the like desired by the demander corresponding to the specification of the commodity. Finally when an input of a number to order is received (ST8h), the memory area 6 for material information or the memory area 7 for processing information of the server computer 5 is searched based on an input condition and names, addresses or telephone numbers of the registered material supplier or the processor are read out from the memory areas 70, 80 for main information and output to the client computer 4 (ST8i, ST9). The image 64 of the finished commodity stored in the memory area 6 for commodity information of the server computer 5 is output and shown on the display of the client computer 4 so as to image an appearance of the finished commodity. In addition, as a reply to the screen to quote, an estimated price is displayed according to the information on the selected material or the processing. Further, a general appointed date of delivery is output and shown in a display of the client computer 5 based on the information on the appointed date of delivery stored in the memory area 7 for material information and the memory area 8 for processing information according to the selected material or the processing method.

In accordance with the arrangement of the embodiment, since the material supplier registers the information on the material which the material supplier can provide and the processor registers the information on the range of the service of processing which the processor can provide and the demander can select the material or the processing method, the material supplier or the processor can provide material or a processing method which meets the demander's needs without a necessity of knowing the demander's needs. In addition, in this embodiment since thinned-out woods with low demand are used as the material and the demander selects the material from among thus registered thinned-out woods, it is possible to utilize the thinned-out woods which meet a demand.

In the system wherein material or a method of processing can be selected arbitrary the manufacturer making a final commodity discloses a required specification concerning material or a method of processing. This makes it possible for the furniture manufacturer to be free from inconvenience in materials or processing during a process of making furniture. In addition, it becomes smooth for the material supplier or the processor to register the information because a range of the information to be disclosed by the material supplier or the processor becomes clear.

This invention is not limited to the above-mentioned embodiment and may be variously modified. More specifically, in the embodiment of the invention both of the species of the thinned-out wood and the processor can be selected, however, only the species of the thinned-out wood may be selected. In the above embodiment the thinned-out wood is explained as an example of the material, however, the material is not limited to this. The above embodiment can be applied to any industries as far as material supply and processing business are independent, for example, to an industry to make fish sausage in which each of the businesses of supplying fish and processing fish is independent.

In this embodiment the server computer 5 is explained as a body separated from the client computers 1 through 4, however, the client computer 1 of the furniture manufacturer and the server computer 5 may be integrated. Further, each of the client computers 1 through 4 may be integrated with other client computer, for example, the client computer 1 of the furniture manufacturer may also serve as the client computer 4 of the demander. In this case, for example, when the furniture manufacturer supplies a local self-governing body with a large number of conference desks, the furniture manufacturer can select a material supplier or a processor locating in an area of the local self-governing body, thereby to contribute to promotion for the area of the local self-governing body.

In addition, in this embodiment the input information on a desired commodity, material or processing is received and searched in the server computer 5 and the conformed result information is output, however, an embodied form is not limited to this. As another way, all of the information restored in the memory area 6 for commodity information, the memory area 7 for material information and the memory area 8 for processing information may be shown in the screen of the client computer 4 so that the desired information can be selected and input from among the information shown in the screen. Especially in a case wherein information on the material or processing registered in the server computer 5 is small, it can reduce time to input required to search the information or time to search the information.

As mentioned above, in the present claimed invention the material supplier registers information on the material that the supplier can supply and the processor registers information on the processing that the processor can provide. Then a person who intends to purchase a specific commodity inputs desired information on the material or the processing for the commodity and information on the material or the processing is output based on the desired information. As a result, the demander can select the material or the processing, thereby to manufacturer a commodity suitable for the demander's preference.

Further, since the required specification for components of the commodity is disclosed in advance and information on the material or the processing corresponding to the specification is registered in registration of information on the material or the processing, the manufacturer that makes a final commodity can make the commodity smoothly and improve the quality of the commodity.

In addition, since thinned-out woods which have conventionally less utility value are registered, information that the demander desires for the thinned-out woods is received and the information on the thinned-out woods is output, it becomes possible to effectively utilize the thinned-out woods having a true demand.

1. A system for processing material characterized in comprising a material information receiving means which receives an input of information on material which can be supplied, a processing information receiving means which receives an input of information on processing which can be supplied and a desired information receiving means which receives an input of desired information on desired material and desired processing wherein an output means which outputs information corresponding to the desired information input by the desired information receiving means based on the information which is received and registered by the material information receiving means and the processing information receiving means.

2. A system for processing material characterized in comprising a material information receiving means which receives an input of information on material which can be supplied based on a required specification for constructing elements constituting a commodity, a processing information receiving means which receives an input of information on processing which can be supplied based on the required specification for the constructing elements constituting the commodity and a desired information receiving means which receives an input of desired information on desired material and desired processing wherein an output means which outputs information corresponding to the desired information input by the desired information receiving means based on the information which is received and registered by the material information receiving means and the processing information receiving means.

3. An output unit for information on processing material characterized in comprising a material information memory means which stores information on material which can be supplied, a processing information memory means which stores information on processing which can be supplied and an output means which outputs information corresponding to desired information from among the information stored in said material information memory means and the processing information memory means based on an input of the desired information on the desired material and the desired processing.

4. An output unit for information on processing material characterized in comprising a specification information memory means which stores a required specification for elements constituting a commodity, a material information memory means which stores material information registered corresponding to information on the required specification stored in the specification information memory means, a processing information memory means which stores processing information registered corresponding to the information on the specification stored in the specification information memory means and an output means which outputs information on the material and the processing corresponding to desired information from among the information stored in said material information memory means and the processing information memory means based on an input of the desired information on the desired material and the desired processing.

5. An output unit for information on processing material characterized in comprising a material information memory means which stores information on thinned-out woods which can be supplied and an output means which outputs information corresponding to desired information from among the information stored in the material information memory means based on an input of the desired information on the desired material and processing.

6. An output method for information on processing material characterized in comprising a step to receive and store information on material which can be supplied, a step to receive and store information on processing which can be supplied, a step to receive an input of desired information on the material and the processing and a step to output information on the material and the processing which corresponds to the desired information from among the stored information on the material and the processing when the input of the desired information is received.

7. An output method for information on processing material characterized in comprising a step to disclose a required specification for elements constituting a commodity, a step to receive and store information on material which can be supplied for the disclosed required specification, a step to receive and store information on processing which can be supplied for the disclosed required specification, a step to receive an input of desired information on the material and the processing and a step to output information on the material and the processing which corresponds to the desired information from among the stored information on the material and the processing when the input of the desired information is received.

8. An output method for information on processing material characterized in that comprising a step to receive and store information on thinned-out woods which can be supplied, a step to receive an input of desired information on the thinned-out woods and a step to output information on the thinned-out woods which corresponds to the desired information from among the stored information on the thinned-out woods when the input of the desired information is received.
